(19) United States
(12) Patent Application Publication
(10) Pub. No.: US 2024/0210210 A1
(43) Pub. Date: Jun. 27, 2024

(54) DISPLACEMENT SENSING DEVICE

(71) Applicant: Chia-Chih Shieh, New Taipei City (TW)

(72) Inventor: Chia-Chih Shieh, New Taipei City (TW)

(73) Assignee: iSentek Inc., New Taipei City (TW)

(21) Appl. No.: 18/165,274

(22) Filed: Feb. 6, 2023

(30) Foreign Application Priority Data
Dec. 21, 2022 (TW) 111149124

(51) Int. Cl. G01D 5/14

(52) U.S. Cl. CPC G01D 5/14

(57) ABSTRACT

Provided is a displacement sensing device adapted to sense a displacement of an object. The displacement sensing device includes a magnetic element array, a first magnetic sensor, a second magnetic sensor, a third magnetic sensor and a computing unit. The first magnetic sensor, the second magnetic sensor and the third magnetic sensor are adapted to move relative to the magnetic element array along a column direction, and are configured to sense components of a magnetic field generated by the magnetic element array in the column direction and a row direction. When the magnetic element array moves relative to the first magnetic sensor, the second magnetic sensor and the third magnetic sensor, the computing unit selects a signal sensed by one of the first magnetic sensor, the second magnetic sensor and the third magnetic sensor to compute the displacement of the object.

### CROSS-REFERENCE TO RELATED APPLICATION

This application claims the priority benefit of Taiwan application serial no. 111149124, filed on Dec. 21, 2022. The entirety of the above-mentioned patent application is hereby incorporated by reference herein and made a part of this specification.

### BACKGROUND

### Technical Field

The disclosure relates to a sensing device, and in particular to a displacement sensing device.

### Description of Related Art

Due to the gradual maturity of flexible screen technology, foldable or rollable smartphones with large-size screens packed into smaller spaces appear in the market.

In practice, a rollable screen needs an accurate displacement detection device. Taking smartphones as an example, the system requires a detection stroke of about 30 to 50 mm, and the accuracy needs to be within 0.1 mm. If the technical effect may be realized, it must meet the following requirements. First, during the expansion and contraction process of the rolling mechanism, the display images on the screen must be able to change precisely and synchronously. Second, the system must be able to detect resistance through displacement changes. As far as the concept machines currently developed in the market are concerned, it is still difficult to achieve the first technical function due to the lack of mature displacement detection capabilities. As for the second technical function, if the system lacks a resistance feedback mechanism, if the rolling mechanism is pulled by an external force during the expansion and contraction process, the structure and motor components will be damaged. However, because the displacement detection is not yet mature, it is still difficult to achieve the second technical function. Therefore, for rollable smartphones, the market is still in the product stage of “concept phones.”

In addition to the above stroke and accuracy requirements, for products such as smartphones or notebook computers, because there are a large number of electronic motor devices inside the system, the magnetic sensing displacement detection device must have at least 10 Gauss interference resistance capability, and the surrounding magnetic field must be able to quickly attenuate to reduce interference with surrounding cameras or other precision motor devices.

The traditional magnetic sensing displacement detection device is designed to use an array of magnets and a magnetic field sensor to sense the displacement. However, in such a design, the regions with poor field patterns at the head and tail edges must be deducted mechanically. That is to say, the range that may be used to sense displacement is only the middle area, so the overall volume cannot be reduced.

### SUMMARY

The disclosure provides a displacement sensing device, which may further reduce the volume of the system while meeting the accuracy requirements.

An embodiment of the disclosure provides a displacement sensing device adapted to sense a displacement of an object. The displacement sensing device includes a magnetic element array, a first magnetic sensor, a second magnetic sensor, a third magnetic sensor, and a computing unit. The magnetic element array includes multiple first magnetic elements and multiple second magnetic elements. The first magnetic elements and the second magnetic elements are staggered along a row direction and a column direction to form a 2×n matrix, where n≥6. The first magnetic sensor, the second magnetic sensor, and the third magnetic sensor are disposed on a side of the magnetic element array and disposed equidistantly along the column direction. The first magnetic sensor, the second magnetic sensor and the third magnetic sensor are adapted to move relative to the magnetic element array along the column direction, and are configured to sense components of a magnetic field generated by the magnetic element array in the row direction and the column direction. The computing unit is electrically connected to the first magnetic sensor, the second magnetic sensor and the third magnetic sensor. The magnetic element array or one of the first magnetic sensor, the second magnetic sensor and the third magnetic sensor is connected to the object. When the magnetic element array moves relative to the first magnetic sensor, the second magnetic sensor and the third magnetic sensor, the computing unit selects a signal sensed by one of the first magnetic sensor, the second magnetic sensor and the third magnetic sensor to compute the displacement of the object.

Based on the above, in an embodiment of the disclosure, when the magnetic element array moves relative to the first magnetic sensor, the second magnetic sensor and the third magnetic sensor, the computing unit selects a signal sensed by one of the first magnetic sensor, the second magnetic sensor and the third magnetic sensor to compute the displacement of the object, so that the maximum displacement sensitivity of the displacement sensing device for the object is greater than the length of the magnetic element array. Therefore, the displacement sensing device may further increase the displacement sensing range and reduce the volume while meeting the detection accuracy requirements.

### BRIEF DESCRIPTION OF THE DRAWINGS

FIG. 1A is a schematic top view of a displacement sensing device according to a first embodiment of the disclosure.

FIG. 1B is a schematic side view of the displacement sensing device according to the first embodiment of the disclosure.

FIG. 1C is a schematic view of the connection between the displacement sensing device and an object according to the first embodiment of the disclosure.

FIG. 2 is a graph of magnetic field components sensed by a magnetic sensor of a displacement sensing device according to an embodiment of the disclosure.

FIG. 3 is a graph of the displacement of an object sensed by the displacement sensing device relative to the angle according to an embodiment of the disclosure.

FIG. 4 is a schematic view of the movement of the magnetic sensor relative to the magnetic element array in the displacement sensing device according to the first embodiment of the disclosure.

FIG. 5 is a partial schematic view of a displacement sensing device according to a second embodiment of the disclosure.

FIG. 6 is a graph of the magnetic field generated by the magnetic element array relative to distance in the displacement sensing device according to the second embodiment of the disclosure.

### DESCRIPTION OF EMBODIMENTS

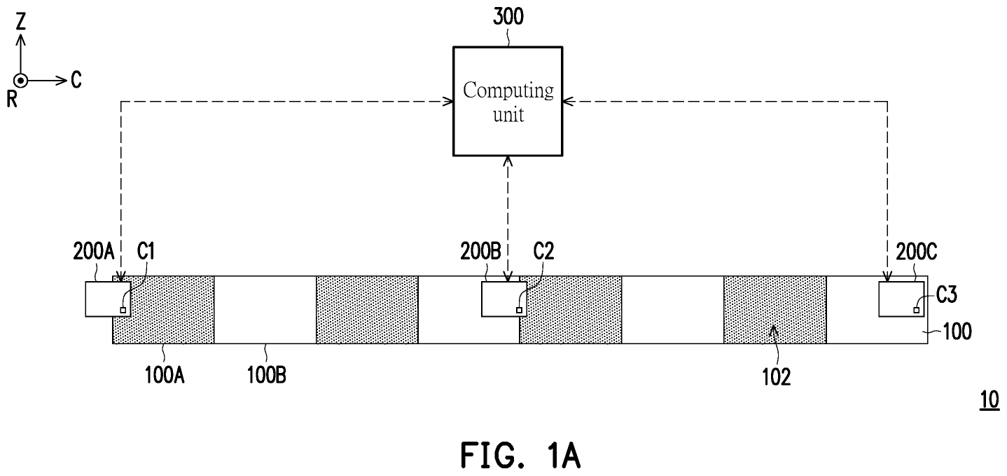

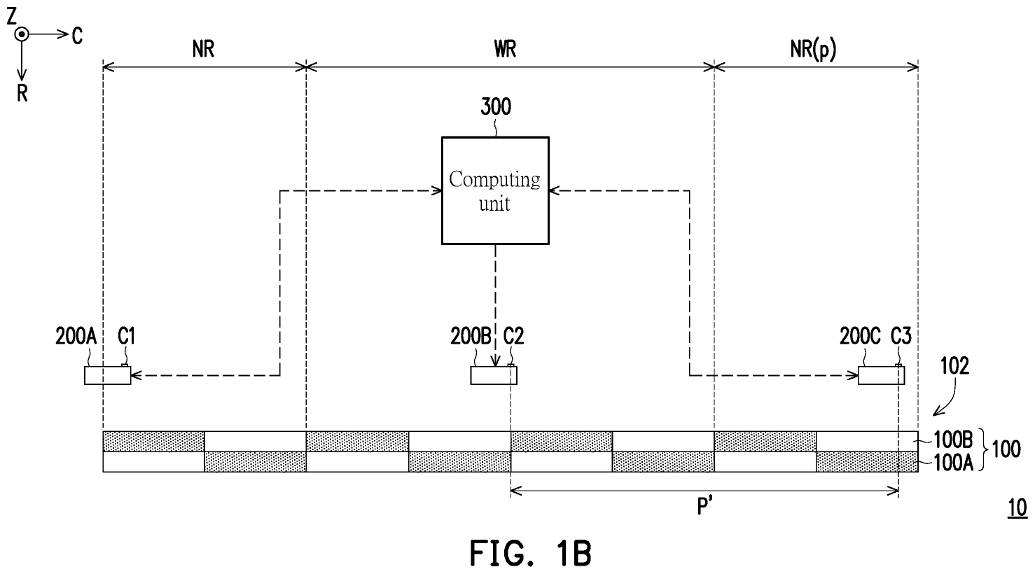

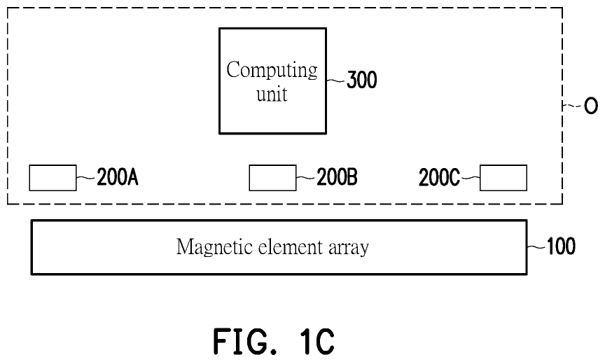

FIG. 1A is a schematic top view of a displacement sensing device according to a first embodiment of the disclosure. FIG. 1B is a schematic side view of the displacement sensing device according to the first embodiment of the disclosure. FIG. 1C is a schematic view of the connection between the displacement sensing device and an object according to the first embodiment of the disclosure. Please refer to FIG. 1A to FIG. 1C. An embodiment of the disclosure provides a displacement sensing device 10 adapted to sense a displacement of an object O. The displacement sensing device 10 includes a magnetic element array 100, a first magnetic sensor 200A, a second magnetic sensor 200B, a third magnetic sensor 200C and a computing unit 300.

In this embodiment, the magnetic element array 100 includes multiple first magnetic elements 100A and multiple second magnetic elements 100B. The first magnetic elements 100A and the second magnetic elements 100B are, for example, N pole and S pole magnets or S pole and N pole magnets, respectively. The first magnetic elements 100A and the second magnetic elements 100B are staggered along the row direction R and the column direction C to form a 2×n matrix, where n=6. In this embodiment, n is preferably an even number.

In this embodiment, the first magnetic sensor 200A, the second magnetic sensor 200B and the third magnetic sensor 200C may be three-axis magnetic sensors. The first magnetic sensor 200A, the second magnetic sensor 200B, and the third magnetic sensor 200C are disposed beside one side 102 of the magnetic element array 100 and disposed equidistantly along the column direction C.

In this embodiment, the first magnetic sensor 200A, the second magnetic sensor 200B and the third magnetic sensor 200C are adapted to move relative to the magnetic element array 100 along the column direction C, and are configured to sense components of a magnetic field generated by the magnetic element array 100 in the row direction R and the column direction C. The computing unit 300 is electrically connected to the first magnetic sensor 200A, the second magnetic sensor 200B and the third magnetic sensor 200C. The magnetic element array 100 or one of the first magnetic sensor 200A, the second magnetic sensor 200B and the third magnetic sensor 200C is connected to the object O. When the magnetic element array 100 moves relative to the first magnetic sensor 200A, the second magnetic sensor 200B and the third magnetic sensor 200C, the computing unit 300 selects a signal sensed by one of the first magnetic sensor 200A, the second magnetic sensor 200B and the third magnetic sensor 200C to compute the displacement of the object O.

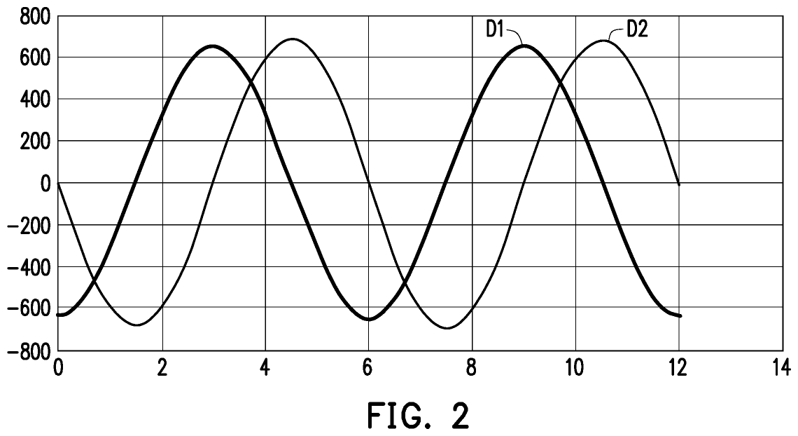

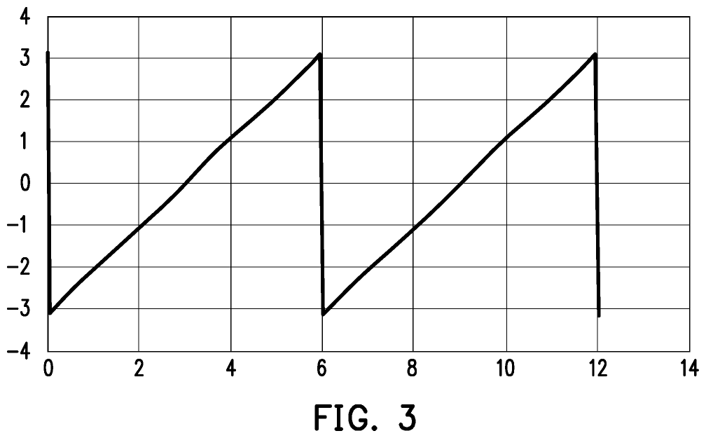

FIG. 2 is a graph of magnetic field components sensed by a magnetic sensor of a displacement sensing device according to an embodiment of the disclosure. FIG. 3 is a graph of the displacement of an object sensed by the displacement sensing device relative to the angle according to an embodiment of the disclosure. In FIG. 2, the horizontal axis is the displacement, and the vertical axis is the magnetic flux. The curve D1 may be the component Bx of the magnetic field along the column direction C, and the curve D2 may be the component By of the magnetic field along the row direction R. In FIG. 3, the horizontal axis is the displacement, and the vertical axis is the angle. In FIG. 2, the curve D1 is, for example, a sin function, and the curve D2 is, for example, a cos function. Therefore, by obtaining the above-mentioned components Bx, By, and by formula (1),

$$Dp = \frac{p}{2 π} ( {tan}^{- 1} \frac{By}{Bx} + θ ) \qquad ( 1 )$$

the displacement of the object O within each pitch p may be computed, where the pitch p is defined as the pitch between the first magnetic elements 100A or the second magnetic elements 100B along the column direction C, and θ is a constant. Therefore, after Dpt=m*p+Dp is further computed, the displacement of the object O may be obtained, as shown in FIG. 3, where m is the number of pitches that the magnetic sensors 200A, 200B, and 200C have moved. In FIG. 3, θ is chosen to be x such that the period of the graph is 0 to 2π.

In detail, in this embodiment, the magnetic element array 100 forms a sensing magnetic field region on the side 102. The sensing magnetic field region includes a working region WR and a non-working region NR. The projection of the working region WR on the side 102 of the magnetic element array 100 falls within the range of the array formed by the first magnetic elements 100A and the second magnetic elements 100B in the column direction C except for the head and the tail p, and the projection of the non-working region NR on the side 102 of the magnetic element array 100 falls within the range of the head and tail p of the array formed by the first magnetic elements 100A and the second magnetic elements 100B in the column direction C. That is to say, the total length of the array of the first magnetic elements 100A and the second magnetic elements 100B in the column direction C is (n/2)*p, and the working region WR is the range of ((n/2)−2)*p in the middle of the sensing magnetic field region.

Taking FIG. 1B as an example, n=8. Therefore, the total length of the array of the first magnetic elements 100A and the second magnetic elements 100B in the column direction C is 4p, and the working region is the range of 2p in the middle of the sensing magnetic field region.

In this embodiment, the sensing center C1, C2 and C3 of one of the first magnetic sensor 200A, the second magnetic sensor 200B, and the third magnetic sensor 200C selected by the computing unit 300 to compute the displacement of the object O is located in the working region WR. That is to say, the maximum displacement of the first magnetic sensor 200A, the second magnetic sensor 200B and the third magnetic sensor 200C or the magnetic element array 100 is preferably limited by the condition that “when the first magnetic sensor 200A, the second magnetic sensor 200B and the third magnetic sensor 200C move relative to the magnetic element array 100 along the column direction C, at least one magnetic sensor 200A, 200B, 200C is located in the working region WR.” Therefore, in a preferred embodiment, the maximum displacement sensitivity of the displacement sensing device 10 is (n−2)*p.

Taking FIG. 1B as an example, n=8. Therefore, the maximum displacement sensitivity of the displacement sensing device 10 is 6p.

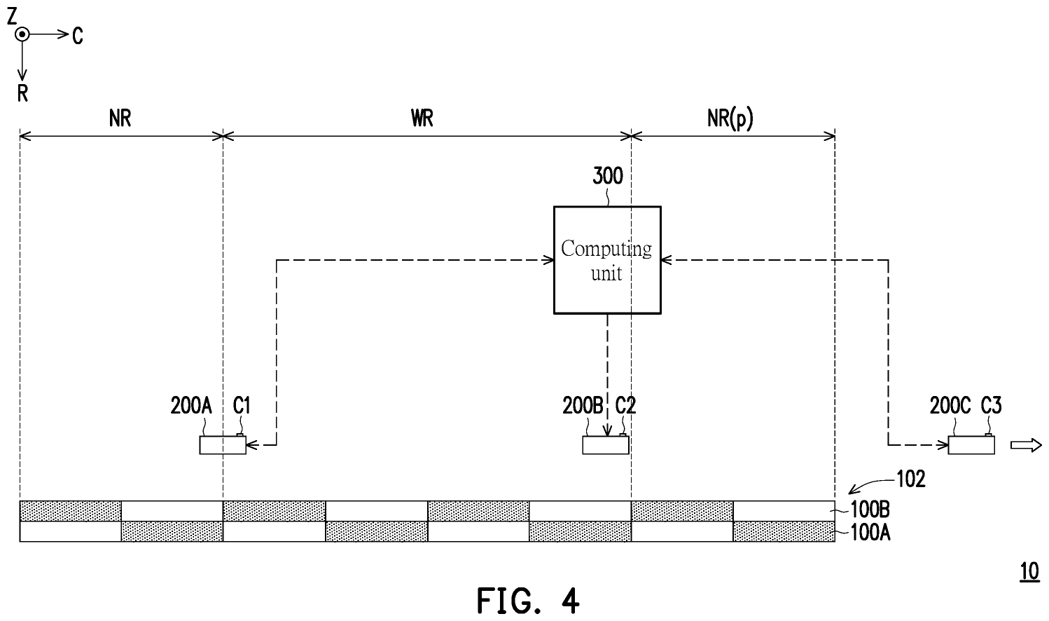

FIG. 4 is a schematic view of the movement of the magnetic sensor relative to the magnetic element array in the displacement sensing device according to the first embodiment of the disclosure. Please refer to FIG. 4. In this embodiment, when the sensing centers C1 and C2 of the first magnetic sensor 200A and the second magnetic sensor 200B are located in the working region WR at the same time, and the first magnetic sensor 200A, the second magnetic sensor 200B and the third magnetic sensor 200C move relative to the magnetic element array 100 in the column direction C (also the arrangement direction of the first magnetic sensor 200A, the second magnetic sensor 200B and the third magnetic sensor 200C), the computing unit 300 selects the signal sensed by the first magnetic sensor 200A to compute the displacement of the object O. In addition, when the sensing centers C1 and C2 of the first magnetic sensor 200A and the second magnetic sensor 200B are located in the working region WR at the same time, and the first magnetic sensor 200A, the second magnetic sensor 200B and the third magnetic sensor 200C move relative to the magnetic element array 100 in a direction opposite to the column direction C, the computing unit 300 selects the signal sensed by the second magnetic sensor 200B to compute the displacement of the object O.

Similarly, in this embodiment, when the sensing centers C2 and C3 of the second magnetic sensor 200B and the third magnetic sensor 200C are located in the working region WR at the same time, and the first magnetic sensor 200A, the second magnetic sensor 200B and the third magnetic sensor 200C move relative to the magnetic element array 100 in the column direction C, the computing unit 300 selects the signal sensed by the second magnetic sensor 200B to compute the displacement of the object O. In addition, when the sensing centers C2 and C3 of the second magnetic sensor 200B and the third magnetic sensor 200C are located in the working region WR at the same time, and the first magnetic sensor 200A, the second magnetic sensor 200B and the third magnetic sensor 200C move relative to the magnetic element array 100 in a direction opposite to the column direction C, the computing unit 300 selects the signal sensed by the third magnetic sensor 200C to compute the displacement of the object O.

Take the change from FIG. 1B to FIG. 4 as an example. In FIG. 1B, only the second magnetic sensor 200B is located in the working region WR. Therefore, the computing unit 300 selects the signal sensed by the second magnetic sensor 200B to compute the displacement of the object O. When the first magnetic sensor 200A, the second magnetic sensor 200B, and the third magnetic sensor 200C continue to move to the right, and the first magnetic sensor 200A also enters the working region WR, in the design of a relay race, the computing unit 300 selects the signal sensed by the first magnetic sensor 200A to compute the displacement of the object O.

In this embodiment, the pitch p′ of the first magnetic sensor 200A, the second magnetic sensor 200B and the third magnetic sensor 200C disposed along the column direction C is smaller than n*p/4. Taking FIG. 1B as an example, n=8. Therefore, the pitch p′ of the first magnetic sensor 200A, the second magnetic sensor 200B, and the third magnetic sensor 200C along the column direction C is less than 2p.

In an embodiment, the computing unit 300 includes, for example, a central processing unit (CPU), a microprocessor, a digital signal processor (DSP), a programmable controller, a programmable logic device (PLD) or other similar devices or a combination of these devices, which is not limited in the disclosure. In addition, in an embodiment, each function of the computing unit 300 may be implemented as multiple program codes. These program codes are stored in a memory unit, and are executed by the computing unit 300. Alternatively, in an embodiment, each function of the computing unit 300 may be implemented as one or more circuits. The disclosure does not limit the implementation of the functions of the computing unit 300 by software or hardware.

Based on the above, in an embodiment of the disclosure, the displacement sensing device includes the magnetic element array 100, the first magnetic sensor 200A, the second magnetic sensor 200B, the third magnetic sensor 200C and the computing unit 300. When the magnetic element array 100 moves relative to the first magnetic sensor 200A, the second magnetic sensor 200B and the third magnetic sensor 200C, the computing unit 300 selects a signal sensed by one 10 of the first magnetic sensor 200A, the second magnetic sensor 200B and the third magnetic sensor 200C to compute the displacement of the object O, so that the maximum displacement sensing of the displacement sensing device 10 for the object O is greater than the length of the magnetic element array 100. Therefore, the displacement sensing device 10 may further increase the displacement sensing range while meeting the detection accuracy requirements. That is to say, under the condition of the same sensing range, the volume of the displacement sensing device 10 may be further reduced.

In addition, in an embodiment of the disclosure, the column direction C and the row direction R in which the magnetic elements 100A and 100B are disposed in the magnetic element array 100 are not limited to a straight line. For example, the column direction C and the row direction R may be arc-shaped or other linear shapes. Therefore, the displacement sensing device 10 may be flexibly applied in various electronic products. When the displacement sensing device 10 satisfies the condition that “the pitch p′ of the first magnetic sensor 200A, the second magnetic sensor 200B, and the third magnetic sensor 200C along the column direction C is less than n*p/4,” the system may have the magnetic sensors 200A, 200B or 200B, 200C in the working region WR at the same time. Therefore, the region where the sensing regions overlap may be used as a data transfer region, thereby improving detection accuracy.

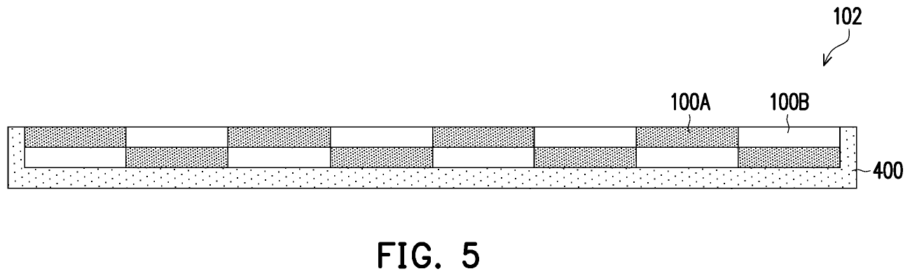

FIG. 5 is a partial schematic view of a displacement sensing device according to a second embodiment of the disclosure. For convenience of illustration, FIG. 5 only shows the magnetic element array 100 and a magnetic permeable material layer 400 in the displacement sensing device, and the rest of the parts are similar to FIG. 1B. Please refer to FIG. 5. The displacement sensing device according to the second embodiment of the disclosure is substantially the same as the displacement sensing device 10, the main differences are as follows. In this embodiment, the displacement sensing device further includes a magnetic permeable material layer 400 covering the other sides of the magnetic element array 100.

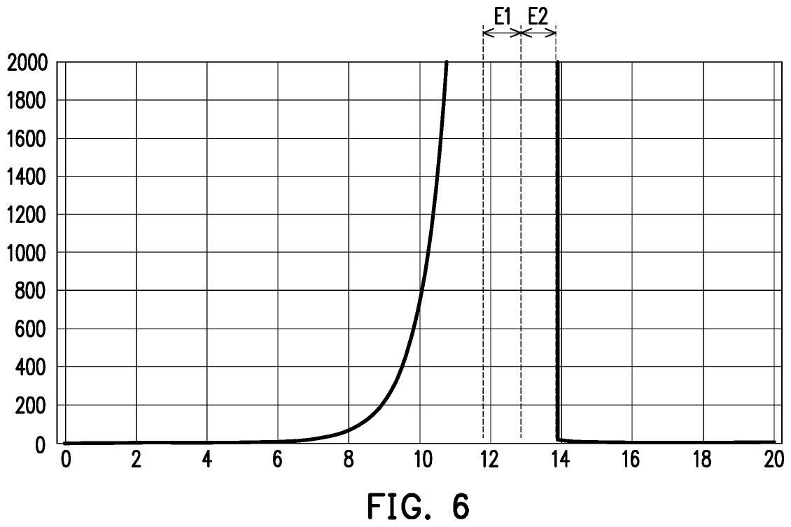

FIG. 6 is a graph of the magnetic field generated by the magnetic element array relative to distance in the displacement sensing device according to the second embodiment of the disclosure. In FIG. 6, the horizontal axis is the distance (mm); the vertical axis is the magnetic flux (Gauss); the range E1 is the disposition range of the magnetic element array 100 in the row direction R; and the range E2 is the disposition range of the magnetic permeable material layer 400. The direction to the left of the range E1 is toward the side 102 of the magnetic element array 100, which is the above-mentioned sensing magnetic field region. On the right side of the range E2 is the region facing away from the sensing magnetic field. In an embodiment of the disclosure, since the displacement sensing device is provided with the magnetic permeable material layer 400 covering the magnetic element array 100, the magnetic field of the displacement sensing device in the region facing away from the sensing magnetic field may rapidly attenuate with distance. When the displacement sensing device is applied to other electronic products, the displacement sensing device may meet the requirements of the system against magnetic field interference. Other advantages of the displacement sensing device in this embodiment of the disclosure are similar to those of the displacement sensing device 10, and will not be repeated here.

To sum up, in an embodiment of the disclosure, the displacement sensing device is designed such that when the magnetic element array moves relative to the first magnetic sensor, the second magnetic sensor and the third magnetic sensor, the computing unit selects a signal sensed by one of the first magnetic sensor, the second magnetic sensor and the third magnetic sensor to compute the displacement of the object, so that the maximum displacement sensitivity of the displacement sensing device for the object is greater than the length of the magnetic element array. Therefore, the displacement sensing device may further increase the displacement sensing range while meeting the detection accuracy requirements. That is to say, under the condition of the same sensing range, the volume of the displacement sensing device may be further reduced.

What is claimed is:

1. A displacement sensing device adapted to sense a displacement of an object, comprising:
a magnetic element array comprising a plurality of first magnetic elements and a plurality of second magnetic elements, wherein the first magnetic elements and the second magnetic elements are staggered along a row direction and a column direction to form a 2×n matrix, where n≥6;
a first magnetic sensor, a second magnetic sensor, and a third magnetic sensor disposed on a side of the magnetic element array and disposed equidistantly along the column direction, wherein the first magnetic sensor, the second magnetic sensor and the third magnetic sensor are adapted to move relative to the magnetic element array along the column direction, and are configured to sense components of a magnetic field generated by the magnetic element array in the row direction and the column direction; and
a computing unit electrically connected to the first magnetic sensor, the second magnetic sensor and the third magnetic sensor,
wherein the magnetic element array or one of the first magnetic sensor, the second magnetic sensor and the third magnetic sensor is connected to the object, and
when the magnetic element array moves relative to the first magnetic sensor, the second magnetic sensor and the third magnetic sensor, the computing unit selects a signal sensed by one of the first magnetic sensor, the second magnetic sensor and the third magnetic sensor to compute the displacement of the object.

2. The displacement sensing device according to claim 1, wherein the magnetic element array forms a sensing magnetic field region on the side, and the sensing magnetic field region comprises a working region and a non-working region,
wherein a projection of the working region on the side of the magnetic element array falls within a range of an array formed by the first magnetic elements and the second magnetic elements in the column direction except for a head and tail p,
a projection of the non-working region on the side of the magnetic element array falls within a range of the head and tail p of the array formed by the first magnetic elements and the second magnetic elements in the column direction, and
p is a pitch between the first magnetic elements or the second magnetic elements along the column direction.

3. The displacement sensing device according to claim 2, wherein a sensing center of the one of the first magnetic sensor, the second magnetic sensor, and the third magnetic sensor selected by the computing unit to compute the displacement of the object is located in the working region.

4. The displacement sensing device according to claim 3, wherein when sensing centers of the first magnetic sensor and the second magnetic sensor are both located in the working region simultaneously, and the first magnetic sensor, the second magnetic sensor and the third magnetic sensor move relative to the magnetic element array in the column direction, the computing unit selects a signal sensed by the first magnetic sensor to compute the displacement of the object, and
when the sensing centers of the first magnetic sensor and the second magnetic sensor are located in the working region simultaneously, and the first magnetic sensor, the second magnetic sensor and the third magnetic sensor move relative to the magnetic element array in a direction opposite to the column direction, the computing unit selects a signal sensed by the second magnetic sensor to compute the displacement of the object.

5. The displacement sensing device according to claim 3, wherein when sensing centers of the second magnetic sensor and the third magnetic sensor are located in the working region simultaneously, and the first magnetic sensor, the second magnetic sensor and the third magnetic sensor move relative to the magnetic element array in the column direction, the computing unit selects a signal sensed by the second magnetic sensor to compute the displacement of the object, and
when the sensing centers of the second magnetic sensor and the third magnetic sensor are located in the working region simultaneously, and the first magnetic sensor, the second magnetic sensor and the third magnetic sensor move relative to the magnetic element array in a direction opposite to the column direction, the computing unit selects a signal sensed by the third magnetic sensor to compute the displacement of the object.

6. The displacement sensing device according to claim 1, wherein the first magnetic sensor, the second magnetic sensor and the third magnetic sensor are three-axis magnetic sensors.

7. The displacement sensing device according to claim 1, wherein a maximum displacement sensitivity of the displacement sensing device is (n−2)*p, where p is a pitch between the first magnetic elements or the second magnetic elements along the row direction.

8. The displacement sensing device according to claim 1, wherein n is an even number.

9. The displacement sensing device according to claim 1, wherein a spacing between the first magnetic sensor, the second magnetic sensor and the third magnetic sensor along the column direction is less than n*p/4, where p is a pitch between the first magnetic elements or the second magnetic elements along the row direction.

10. The displacement sensing device according to claim 1, further comprising:
a magnetic permeable material layer covering other sides of the magnetic element array.
